(19) United States
(12) Patent Application Publication
(10) Pub. No.: US 2005/0196563 A1
(43) Pub. Date: Sep. 8, 2005

(54) Heat shrinkable polyester film

(76) Inventors: Hideki Ito, Inuyama-shi (JP); Masatosi Hashimoto, Inuyama-shi (JP); Yukinobu Mukouyama, Inuyama-shi (JP); Norimi Tabota, Inuyama-shi (JP); Tsutomu Oko, Inuyama-shi (JP)

Correspondence Address: KENYON & KENYON, 1500 K STREET NW, SUITE 700, WASHINGTON, DC, 20005, US

(21) Appl. No.: 11/035,074

(22) Filed: Jan. 14, 2005

Related U.S. Application Data
(63) Continuation of application No. 09/492,173, filed on Jan. 27, 2000.

(30) Foreign Application Priority Data
Jan. 28, 1999 (JP) 11-020836
Mar. 8, 1999 (JP) 11-060898
Apr. 23, 1999 (JP) 11-117338
Apr. 23, 1999 (JP) 11-117339
Apr. 23, 1999 (JP) 11-117340

(51) Int. Cl. B32B 1/08

(52) U.S. Cl. 428/34.1

(57) ABSTRACT

A heat shrinkable polyester film of the present invention has a transverse tear defect percentage of about 20% or less as determined in the following vibration test: the film is rolled into a tubular shape, two of its opposite edges bonded together, and then the tubular film is placed around a vertical stack (total weight: 660 g) of three food container cans each having a diameter of 72 mm and a height of 55 mm; the can stack with the tubular film placed therearound is passed through a shrink tunnel to shrink the tubular film onto the can stack; a total of 18 packs of such can stacks are placed into a cardboard box having a length of 455 mm, a width of 230 mm and a height of 165 mm (6 packs in the length direction by 3 packs in the width direction), and the cardboard box is sealed; the cardboard box is vibrated along the width direction for 30 min by a stroke of 50 mm and at a vibration rate of 180 reciprocations/min, after which the transverse tearage of the tubular film is visually observed; and the transverse tear defect percentage (%) is determined based on the number of defective packs per 18 packs, wherein the defective pack is any pack having a tear flaw of 30 mm or longer along a can periphery. The heat shrinkable polyester film of the present invention has a good shock resistance during shipping especially under low temperatures, with a good finish after shrinkage and a sufficient solvent adhesiveness. Thus, the heat shrinkable polyester film of the present invention is suitable for use in a multi-packaging label for packaging, inter alia, a stack of cans.

### BACKGROUND OF THE INVENTION

1. Field of the Invention

The present invention relates to a heat shrinkable polyester film, and particularly to a heat shrinkable polyester film suitable for use in a label. More particularly, the present invention relates to a heat shrinkable polyester film for use in a multi-packaging label for packaging, inter alia, a stack of cans, which has a good shock resistance during shipping, especially under low temperatures, with a good finish after shrinkage and a sufficient solvent adhesiveness (i.e., an adhesive property of the film provided by application of a solvent thereon). The present invention further relates to a heat shrinkable polyester film for use in a cap sealing label for a bottle container (e.g., a milk bottle), in which a bonded portion (backlining portion) of the label (i.e. a portion of a tubular label where two opposite edges of the material film sheet are bonded together) has a high adhesive retention after shrinkage and which has very little creasage, shrinkage non-uniformity, distortion, or jumping occurring from a shrinkage process.

2. Description of the Related Art

Heat shrinkable films made of polyvinyl chloride, polystyrene, or the like, have been widely used in the field of multi-packaging films for use in packaging a stack of cans. In recent years, heat shrinkable polyester films have been attracting public attention as more problems have been found to exist with the former materials. That is, polyvinyl chloride products generate a chlorine gas when incinerated, and it is difficult to print on polystyrene products.

However, when a stack of articles is shrink-packaged with a label of a conventional heat shrinkable polyester film, a flaw is likely to occur due to, for example, a shock applied when the article stack hits another article stack during shipping or a friction between the article stack and the outer packaging box therearound. Moreover, because such a conventional film is drawn in one direction in the production process, the film is likely to be torn for a substantial length along its main shrinkage direction, in which case the film can no longer hold articles therein, thereby detracting from the commercial value of the articles. Even a state-of-the-art multi-packaging polyvinyl chloride film, which is supposed to be flexible and tear-resistant, may be torn especially under low temperatures.

One possible way to prevent such tearing along a particular direction is to orient a film along a direction perpendicular to its main shrinkage direction as well as the main shrinkage direction. However, when the film is oriented along these two directions with a poor balance between the directions, the film may be shrunk with a poor balance between the directions, thereby resulting in a poor finish after shrinkage. Moreover, when a tube is produced from the film by using an environmentally preferred chlorine-free solvent, a sufficient solvent adhesiveness cannot be obtained.

In recent years, a container (e.g., a bottle) for beverage, food, etc., is provided with a so-called “cap seal” wrapped around the cap or lid of the container. The cap seal is provided not only for decorative purposes but also for purposes of preventing someone from mixing poison into the contained product. A heat shrinkable film of polyvinyl chloride, polystyrene, or the like, has been widely used in a cap sealing label, as in a general purpose label. However, as already noted above, more problems have been found to exist with these materials (polyvinyl chloride products generate a chlorine gas when incinerated, and it is difficult to print on polystyrene products). Moreover, in order to effectively recycle PET bottles, it is necessary to collect non-PET labels made of polyvinyl chloride, polystyrene, etc., separately from PET labels. Thus, there is a need for cap sealing labels made of these environmentally preferred polyester heat shrinkable films.

A cap seal may be produced as follows. First, a sheet of heat shrinkable film having a predetermined size is rolled into a tubular shape with two of its opposite edges bonded together. Then, the tubular film is cut into smaller tubular label pieces.

There are two ways as follows that are typically employed in cap sealing processes. One way is to directly place a label produced as described above around the container and shrink the label onto the container. The other way is to first shrink the label onto a metal mold to provide a “preform” product, and then further shrink the label onto the container. In either case, when the label is heat-shrunk, the bonded portion (backlining portion) of the label desirably stays bonded together. If the bonded portion falls apart, the productivity decreases substantially.

Moreover, the shape characteristics of the label after it is heat-shrunk are also important. It is undesirable that the label does not shrink enough, or the shrunk label has creasage, shrinkage. non-uniformity, distortion, or jumping. Particularly when the label is used for a food container, it is in many cases undesirable for the label to get moist. Therefore, in such a case, the heat shrinkage process is typically done using hot air instead of steam. When using hot air, however, the heat efficiency is lower than that when using steam, whereby it is likely that the film does not shrink enough, or the shrunk label has creasage, shrinkage non-uniformity, distortion.

When the heat shrinkable film is used as a cap'sealing label with nothing printed thereon, in many cases, the film is also required to have transparency.

### SUMMARY OF THE INVENTION

According to one aspect of this invention, a heat shrinkable polyester film has a transverse tear defect percentage of about 20% or less as determined in the following vibration test: the film is rolled into a tubular shape, two of its opposite edges bonded together, and then the tubular film is placed around a vertical stack (total weight: 660 g) of three food container cans each having a diameter of 72 mm and a height of 55 mm; the can stack with the tubular film placed therearound is passed through a shrink tunnel to shrink the tubular film onto the can stack; a total of 18 packs of such can stacks are placed into a cardboard box having a length of 455 mm, a width of 230 mm and a height of 165 mm (6 packs in the length direction by 3 packs in the width direction), and the cardboard box is sealed; the cardboard box is vibrated along the width direction for 30 min by a stroke of 50 mm and at a vibration rate of 180 reciprocations/min, after which the transverse tearage of the tubular film is visually observed; and the transverse tear defect percentage (%) is determined based on the number of defective packs per 18 packs, wherein the defective pack is any pack having a tear flaw of 30 mm or longer along a can periphery.

In one embodiment of the invention, the film has a longitudinal refractive index Nx and a transverse refractive index Ny which satisfy the following expressions (1) and (2):
1.561<Nx<1.566 (1); and
0.040<Ny−Nx<0.070 (2)

In one embodiment of the invention, the film has a shrinkage of about 50% or more along its main shrinkage direction when the film is put in hot water of 95° C. for 10 sec.

In one embodiment of the invention, the film has a shrinkage of about 10% to about 25% along a direction perpendicular to its main shrinkage direction when the film is put in hot water of 95° C. for 10 sec.

In one embodiment of the invention, the film has a solvent adhesiveness with 1,3-dioxolane.

In one embodiment of the invention, the film can be used as a multi-packaging film.

According to another aspect of this invention, a heat shrinkable polyester film is provided, wherein: the film has a shrinkage of about 10% to about 40% along its main shrinkage direction when the film is put in hot water of 70° C. for 5 sec; the film has a shrinkage of about 50% or more along its main shrinkage direction when the film is put in hot water of 95° C. for 5 sec; the film has a shrinkage of about 10% or less along a direction perpendicular to its main shrinkage direction when the film is put in hot water of 95° C. for 5 sec; and when the film is formed into a label having a bonded portion, the bonded portion of the label has an adhesive retention of about 95% or more after shrinkage.

In one embodiment of the invention, the bonded portion of the label has an adhesive retention of about 97% or more after shrinkage.

In one embodiment of the invention, the bonded portion of the label has an adhesive retention of about 99% or more after shrinkage.

In one embodiment of the invention, the bonded portion of the label has an adhesive retention of about 99.5% or more after shrinkage.

In one embodiment of the invention, the label is a tubular label formed by bonding together two of opposite edges of a rectangular sheet of the film.

In one embodiment of the invention, the bonded portion is a portion of a tubular label made of a rectangular sheet of the film where two of its opposite edges are bonded together.

In one embodiment of the invention, the film is a cap sealing heat shrinkable polyester film.

According to still another aspect of this invention, there is provided a cap sealing label made of a heat shrinkable polyester film as defined above.

According to still another aspect of this invention, a heat shrinkable polyester film is provided, wherein: the film has a shrinkage of about 10% to about 40% along its main shrinkage direction when the film is put in hot water of 70° C. for 5 sec; the film has a shrinkage of about 50% or more along its main shrinkage direction when the film is put in hot water of 95° C. for 5 sec; the film has a shrinkage of about 10% or less along a direction perpendicular to its main shrinkage direction when the film is put in hot water of 95° C. for 5 sec; the film has a film haze of about 3% to 15 about 10% for a film thickness of 50 μm: and when the film is formed into a label having a bonded portion, the bonded portion of the label has an adhesive retention of about 95% or more after shrinkage.

In one embodiment of the invention, the label is a tubular label formed by bonding together two of opposite edges of a rectangular sheet of the film.

In one embodiment of the invention, the bonded portion is a portion of a tubular label made of a rectangular sheet of the film where two of its opposite edges are bonded together.

In one embodiment of the invention, the film is a cap sealing heat shrinkable polyester film.

According to still another aspect of this invention, there is provided a cap sealing label made of a heat shrinkable polyester film as defined above.

According to still another aspect of this invention, there is provided a heat shrinkable polyester film, wherein: the film has a shrinkage of about 10% to about 40% along its main shrinkage direction when the film is put in hot water of 70° C. for 5 sec; the film has a shrinkage of about 50% or more along its main shrinkage direction when the film is put in hot water of 95° C. for 5 sec; the film has a shrinkage of about 10% or less along a direction perpendicular to its main shrinkage direction when the film is put in hot water of 95° C. for 5 sec; the film has a shrinkage of about 15% to about 30% along its main shrinkage direction when the film is put in hot water of 80° C. for 5 sec after a preform process; and when the film is formed into a label having a bonded portion, the bonded portion of the label has an adhesive retention of about 95% or more after shrinkage.

In one embodiment of the invention, the label is a tubular label formed by bonding together two of opposite edges of a rectangular sheet of the film.

In one embodiment of the invention, the bonded portion is a portion of a tubular label made of a rectangular sheet of the film where two of its opposite edges are bonded together.

In one embodiment of the invention, the film is a cap sealing heat shrinkable polyester film.

According to still another aspect of this invention, there is provided a cap sealing label made of a heat shrinkable polyester film as defined above.

According to still another aspect of this invention, there a heat shrinkable polyester film is provided, wherein: the film has a shrinkage of about 10% to about 40% along its main shrinkage direction when the film is put in hot water of 70° C. for 5 sec; the film has a shrinkage of about 50% or more along its main shrinkage direction when the film is put in hot water of 95° C. for 5 sec; the film has a shrinkage of about 10% or less along a direction perpendicular to its main shrinkage direction when the film is put in hot water of 95° C. for 5 sec; the film has a preform finish defective percentage of about 1% or less; and when the film is formed into a label having a bonded portion, the bonded portion of the label has an adhesive retention of about 95% or more after shrinkage.

In one embodiment of the invention, the label is a tubular label formed by bonding together two of opposite edges of a rectangular sheet of the film.

In one embodiment of the invention, the bonded portion is a portion of a tubular label made of a rectangular sheet of the film where two of its opposite edges are bonded together.

In one embodiment of the invention, the film is a cap sealing heat shrinkable polyester film.

According to still another aspect of this invention, there is provided a cap sealing label made of a heat shrinkable polyester film as defined above.

Thus, the invention described herein makes possible the advantages of: (1) providing a heat shrinkable polyester film which has a good shock resistance during shipping especially under low temperatures, with a good finish after shrinkage and a sufficient solvent adhesiveness; (2) providing a heat shrinkable polyester film having such properties for use in a multi-packaging label for packaging, inter alia, a stack of cans; and (3) providing a heat shrinkable polyester film for use in a cap sealing label for a bottle container, in which a bonded portion (backlining portion) of the label has a high adhesive retention after shrinkage and which has very little creasage, shrinkage non-uniformity, distortion, or jumping occurring from a shrinkage process.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic diagram illustrating a vibration test for a heat shrinkable polyester film;

FIG. 2 is a diagram illustrating a vibration test for a heat shrinkable polyester film;

FIG. 3 is a diagram illustrating a case where a tear flaw has occurred in a film along a can periphery;

FIG. 4A is a perspective view illustrating a label produced by rolling a sheet of heat shrinkable film into a tubular shape with two of its opposite edges bonded together, and then cutting the tubular film into smaller pieces;

FIG. 4B is a perspective view illustrating the label being placed around a metal cylinder; and

Each of FIGS. 5A to 5E is a perspective view illustrating the appearance of the label after shrinking (i.e., the preform finish property).

### DESCRIPTION OF THE PREFERRED EMBODIMENTS

A heat shrinkable polyester film according to an embodiment of the present invention will now be described.

(Heat Shrinkable Polyester Film Suitable for use as Multi-Packaging Film)

Preferred polyesters for use in a heat shrinkable polyester film of the present invention suitable for use as a multi-packaging film typically include polyethylene terephthalate, polyethylene naphthalate, and other polyesters obtained by copolymerizing such polyesters with an acid component or a long-chain glycol component of an aliphatic compound.

According to the present invention, in addition to the acid components of the polyester comprising terephthalic acid or naphthalenedicarboxylic acid, it is possible to use one or more known dicarboxylic acids such as oxalic acid, malonic acid, succinic acid, adipic acid, azelaic acid, isophthalic acid, decanedicarboxylic acids, and dimeracid. Moreover, in addition to the diol component comprising butanediol, it is possible to use one or more known diols such as ethylene glycol, neopentyl glycol, hexamethylene glycol, 1,4-cyclohexane dimethanol, dimer acid diol, and ethylene-oxide-added tetramethylene glycol.

In order to obtain a heat shrinkable polyester film which is determined to be desirable in a vibration test, it is preferred to use neopentyl glycol as one of the diol components.

Moreover, in order to improve the smoothness of the heat shrinkable polyester film, the film preferably contain an inorganic lubricant and/or an organic lubricant. Optionally, the film may contain further additives such as a stabilizer, a coloring agent, an antioxidant, a defoamer, and an antistatic agent.

The heat shrinkable polyester film of the present invention is required to have a transverse tear defect percentage of about 20% or less, and preferably about 10% or less, as determined in a vibration test. When the transverse tear defect percentage exceeds 20%, the film is likely to have many tears during actual shipping.

In the present invention, it is further preferred that the refractive indices Nx, Ny of the film satisfy the following expressions (1) and (2):
1.561<Nx<1.566 (1); and
0.040<Ny−Nx<0.070 (2).

The more preferred range of the refractive index Nx is 1.562 to 1.565. The more preferred range of the value (Ny−Nx) is 0.050 to 0.060. When the refractive index Nx is less than 1.561, the strength of the film against transverse tears may be insufficient. When the refractive index Nx exceeds 1.566, the shrinkage of the film along a direction perpendicular to the main shrinkage direction increases, thereby decreasing the shrunk finish property.

When the value (Ny−Nx) is less than 0.040, the shrinkage balance between the longitudinal direction and the transverse direction of the film may be poor, resulting in shrinkage non-uniformity. When the value (Ny−Nx) exceeds 0.070, the transverse tear defect percentage increases.

Preferably, the film of the present invention has a shrinkage of about 50% or more, and more preferably about 55% or more, along its main shrinkage direction when the film is put in hot water of 95° C. for 10 sec. When the hot water shrinkage along the main shrinkage direction is less than 50%, it is likely that the film does not shrink enough, or the shrunk label has shrinkage non-uniformity, thereby resulting in a poor finish.

Preferably, the film of the present invention has a shrinkage of about 10% to about 25%, and more preferably about 10% to about 20%, along a direction perpendicular to its main shrinkage direction when the film is put in hot water of 95° C. for 10 sec. When the hot water shrinkage along this direction is less than 10%, the strength of the film against transverse tears may be insufficient. When hot water shrinkage along this direction exceeds 25%, the shrunk film may have shrinkage non-uniformity or jumping, thereby resulting in a poor finish.

Preferably, the film of the present invention has a solvent adhesiveness with 1,3-dioxolane.

In order to achieve the objects of the present invention, a polyester film having its main shrinkage direction along the transverse (or width) direction is more practical. Therefore, an exemplary film production method where the film has its main shrinkage direction along the transverse direction will be described below. However, it is understood that the present invention is also applicable to a case where the film has its main shrinkage direction along the longitudinal direction.

According to the present invention, a polyester material is first dried by using a dryer or vacuum dryer such as a hopper dryer or a paddle dryer. Then, the polyester. material is extruded at a temperature of 200° C. to 300° C., and rapidly cooled to obtain an undrawn film. In order to produce a heat shrinkable polyester film having its main shrinkage direction along the transverse direction, the obtained undrawn film is typically drawn longitudinally by a drawing factor of 1.1 to 1.3 at 80° C. to 95° C., and then drawn laterally by a drawing factor of 3 to 5 at 70° C. to 85° C. It is understood that any other drawing condition may alternatively be set for this process.

(Heat Shrinkable Polyester Film Suitable for use in Cap Sealing Label)

A heat shrinkable polyester film of the present invention suitable for use in a cap sealing label is preferably produced from a polyester composition containing a polyester comprising a dicarboxylic acid component and a diol component, and a polyester elastomer. The polyester composition may contain 50 wt % to 99.9 wt % of a polyester, and may contain 0.1 wt % to 50 wt % of a polyester elastomer.

The heat shrinkable polyester film of the present invention can be produced by drawing the undrawn film obtained from the above-described polyester composition at a temperature equal to or greater than Tg−5° C. and less than Tg+15° C. (where Tg is the glass-transition temperature of the polyester) along the transverse direction (direction perpendicular to the extrusion direction) by a drawing factor of 3.0 or more, and preferably 3.5 or more.

(Polyester)

The dicarboxylic acid component of the polyester may include aromatic dicarboxylic acids (e.g., terephthalic acid, isophthalic acid, naphthalenedicarboxylic acid, and orthphthalic acid), aliphatic dicarboxylic acids (e.g., adipic acid, azelaic acid, sebacic acid, and decanedicarboxylic acids), alicyclic dicarboxylic acids, or the like.

Where the polyester contains an aliphatic dicarboxylic acid(s) (e.g., adipic acid, sebacic acid, decanedicarboxylic acid, or the like), the content of the aliphatic dicarboxylic acid is preferably less than 3 mol % (this applies to all the dicarboxylic acid components used). A heat shrinkable polyester film obtained by using a polyester which contains 3 mol % or more of such an aliphatic dicarboxylic acid(s) may not have a sufficient rigidity in high-speed processes.

The polyester preferably does not contain a polyvalent carboxylic acid whose valence is 3 or more (e.g., a trimellitic acid, a pyromellitic acid, or anhydride thereof). If the polyester contains such a polyvalent carboxylic acid, the content thereof is preferably 3 mol % or less. With a heat shrinkable polyester film obtained by using a polyester containing such a polyvalent carboxylic acid, a sufficient shrinkage may not be achieved.

A diol component of the polyester to be used in the present invention may include aliphatic diols (e.g., ethylene glycol, propane diol, butane diol, neopentyl glycol, hexane diol, or the like), alicyclic diols (e.g., 1,4-cyclohexane dimethanol), aromatic diols, or the like.

A polyester used in the heat shrinkable polyester film of the present invention is preferably a polyester whose glass-transition temperature (Tg) is adjusted to 60° C. to 75° C. by mixing therein one or more diols whose carbon number is 3 to 6 (e.g., propane diol, butane diol, neopentyl glycol, and hexane diol).

In order to obtain a heat shrinkable polyester film having a particularly desirable shrunk finish property, it is preferred to use neopentyl glycol as one of the diol components, preferably in an amount of 15 mol % to 25 mol % (this applies to all the diol components used).

It is preferable not to include a diol whose carbon number is 8 or more (e.g., octanediol) or a polyalcohol whose valence is 3 or more (e.g., trimethylolpropane, trimethylolethane, glycerin, and diglycerin). If such a diol or such a polyalcohol is included, the content thereof is preferably 3 mol % or less. With a heat shrinkable polyester film obtained by using a polyester containing such a diol or such a polyalcohol, a sufficient shrinkage may not be achieved.

The polyester preferably contains the least amount possible of diethylene glycol, triethylene glycol, and polyethylene glycol. Particularly, diethylene glycol is likely to be present because it is a byproduct from a polyester polymerization process. Nevertheless, in the polyester used in the present invention, the content of diethylene glycol is preferably less than 4 mol %.

When two or more polyesters are mixed together, the acid component content or the diol component content is the content with respect to the acid component or the diol component, respectively, of all the polyesters. These contents are irrespective of whether ester interchange occurs after mixing.

The above-described polyesters can be produced by any conventional method. For example, the polyester can be obtained by using, for example, a direct esterification method, where a dicarboxylic acid and a diol are directly reacted with each other, or a transesterification method, where a dimethyl dicarboxylate and a diol are reacted with each other. The polymerization may be performed either in a batch process or a continuous process.

(Polyester Elastomer)

The polyester elastomer (polyester block copolymer) used in the present invention is a polyester block copolymer comprising a high melting point crystalline polyester segment (hard segment) and a low melting point soft polymer segment having a molecular weight of 400 or more (soft segment). When a high polymer is made solely of the high melting point crystalline polyester segment, the melting point is 200° C. or more. The low melting point soft polymer segment itself has a melting point or a softening point of 80° C. or less.

When a fiber-forming high polymer is made solely of the high melting point crystalline polyester segment (hard segment), the melting point is 200° C. or more.

For example, the high melting point crystalline polyester segment may be: a polyester comprising a residue of an aromatic dicarboxylic acid (e.g. , terephthalic acid, isophthalic acid, 1,5-naphthalenedicarboxylic acid, and 2,6-naphthalenedicarboxylic acid) and a residue of an aliphatic, aromatic or alicyclic diol (e.g., ethylene glycol, propylene glycol, tetramethylene glycol, pentamethylene glycol, 2,2-dimethyltrimethylene glycol, hexamethylene glycol, decamethylene glycol, p-xylene glycol, and cyclohexane dimethanol); a polyester comprising a residue of an oxy acid (e.g., p-(β-hydroxyethoxy)benzoate, and p-oxybenzoatepibarolactone); a polyether ester comprising a residue of an aromatic ether dicarboxylic acid (e.g., 1,2-bis(4,4′-dicarboxymethylphenoxy)ethane, di(4-carboxyphenoxy)ethane) and a residue of the above-described aliphatic, aromatic or alicyclic diol; or a polyamide ester comprising a residue of an aromatic amide dicarboxylic acid (e.g., bis (N-paracarboethoxyphenyl)terephthalimide) and a residue of the above-described aliphatic, aromatic or alicyclic diol.

It is also possible to use a copolymer polyester containing two or more of such dicarboxylic acid residues and/or diol residues.

The low melting point soft polymer segment having a molecular weight of 400 or more (soft segment) is a segment in a polyester block copolymer which is substantially amorphous. The segment itself has a melting point or a softening point of 80° C. or less.

The molecular weight of the low melting point soft polymer segment is 400 to 8000, and preferably 700 to 5000.

The ratio of the low melting point soft polymer segment in the polyester elastomer is preferably 1 wt % to 90 wt %, and more preferably 5 wt % to 80 wt %.

Typical low melting point soft polymer segments include a polyether (e.g., polyethylene oxide glycol, polypropylene oxide glycol, polytetramethylene oxide glycol, a glycol of a copolymer of ethylene oxide and propylene oxide, and a glycol of a copolymer of ethylene oxide and tetrahydrofuran), an aliphatic polyester (e.g., polyneopentyl azelate, polyneopentyl adipate, and poly-neopentyl sebacate), polylactone (e.g., poly-ε-caprolactone), and the like.

In view of the compatibility with the polyester included in the polyester film, it is particularly preferred that the polyester elastomer includes polylactone (e.g., poly-ε-caprolactone) as the soft segment. With a better compatibility between the polyester elastomer and the polyester, the film will have a better transparency and the bonded portion (backlining portion) of the label will have a better adhesion.

The polyester elastomer is contained in the polyester composition of the polyester film in an amount of 0.1 wt % to 50 wt %, preferably 0.1 wt % to 30 wt %, and more preferably 5 wt % to 30 wt %.

When the content of the polyester elastomer is less than 0.1 wt % or greater than 50 wt %, the bonded portion (backlining portion) of the label produced from the polyester film of the present invention will have a poor adhesion.

The same additives as those described above may be included to improve the smoothness of the heat shrinkable film. The inorganic lubricant may be, for example, titanium dioxide, fine particle silica, kaoline, or calcium carbonate. The organic lubricant may be, for example, long-chain fatty acid ester.

The hot water shrinkage of a heat shrinkable polyester film can be determined as follows. The film is subjected to a no-load treatment in hot water. Based on the length of the film before shrinkage and that after shrinkage, the hot water shrinkage of the film can be calculated by the expression:
Heat shrinkage=((length before shrinkage−length after shrinkage)/length before shrinkage)×100(%)

The heat shrinkable polyester film of the present invention has a shrinkage of about 10% to about 40%, and preferably about 20% to about 40%, along its main shrinkage direction when the film is put in hot water of 70° C. for 5 sec. The film has a shrinkage of about 50% or more, and preferably about 50% to about 70%, along its main shrinkage direction when the film is put in hot water of 95° C. for 5 sec. The film has a shrinkage of about 10% or less, preferably about 8% or less, and more preferably about 6% or less, along a direction perpendicular to its main shrinkage direction when the film is put in hot water of 95° C. for 5 sec.

For a hot water shrinkage process at 70° C. for 5 sec, when the shrinkage along the main shrinkage direction is less than 10%, the low temperature shrinkage of the film may be insufficient, whereby it may be necessary to increase the shrinkage temperature, which is undesirable. When the shrinkage exceeds 40%, jumping of the label may occur from the heat shrinkage process.

The shrinkage for a hot water shrinkage process at 95° C. for 5 sec is preferably about 50% to about 70%. When the shrinkage is less than 50%, it may be necessary to increase the shrinkage temperature, which is undesirable. When the shrinkage exceeds 70%, the label may still have a shrinking force even after the heat shrinkage process, whereby the label is likely to jump.

The heat shrinkable polyester film of the present invention has a film haze of about 3% to about 10% for a film thickness of 50 μm. When the haze exceeds 10%, there is a practical problem in that the printed label may have a poor color. When the haze is less than 3%, the film thickness distribution may deteriorate.

A label made of the heat shrinkable polyester film of the present invention after a preform process has a hot water shrinkage along the main shrinkage direction of about 15% to about 30%, and more preferably about 17% to about 25% for a hot water shrinkage process at 80° C. for 5sec. When the hot water shrinkage along the main shrinkage direction after the preform process is less than 15%, insufficient shrinkage may occur. When the hot water shrinkage is 30% or more, jumping of the label may occur from the heat shrinkage process.

When the label made of the heat shrinkable polyester film of the present invention is subjected to a preform process, the defect percentage is about 1% or less. A decrease in the production yield is undesirable because it may necessitate a reduction in the productivity, e.g., a reduction in the process speed, in order to reduce the defect.

When the heat shrinkable polyester film of the present invention is formed into a label having a bonded portion (backlining portion), the bonded portion of the label has an adhesive retention of about 97% or more, preferably about 99% or more, and more preferably about 99.5% or more, after shrinkage.

When the heat shrinkable polyester film of the present invention is formed into a label, the label preferably has a compressive strength of about 300 g or more, and more preferably about 400 g or more. While the compressive strength is influenced by the film thickness, the compressive strength is preferably about 300 g or more so that the film can suitably be used with a high-speed label application machine. When the compressive strength is less than 300 g, there may be a label application defective.

The thickness of the heat shrinkable polyester film of the present invention is not limited to any particular value. As a heat shrinkable film for use in a label, the thickness of the film is preferably 10 μm to 200 μm, and more preferably 20 μm to 100 μm.

A cap sealing label can be produced as described above. First, a sheet of heat shrinkable film having a predetermined size is rolled into a tubular shape with two of its opposite edges bonded together. Then, the tubular film is cut into smaller label pieces. The method of bonding is not limited to any particular method. For example, a solvent or a swelling agent is applied on at least one of two opposite edges of the heat shrinkable polyester film, the opposite edges are bonded together before the solvent or the swelling agent dries up.

A halogenated hydrocarbon solvent is particularly recommended for use in the above-described method. The halogenated hydrocarbon solvent comprises low boiling point solvents as follows. Such a low boiling point solvent comprises an aliphatic and aromatic halogenated hydrocarbon, and has a boiling point of 200° C. or less and a vapor pressure of 5 mmHg or more at 20° C. Particularly, in view of the high-speed process, the solvent preferably has a boiling point of 150° C. or less and a vapor pressure of 30 mmHg or more at 20° C.

Specific examples of the solvent include a halogenated aliphatic hydrocarbon (e.g., dichloromethane, chloroform, dichloroacetylene, dichloroethylidene, di-chloroethylene, 1,1,1-trichloroethane, 1,1,2-trichloroethane, 1,1,2,2-tetrachloroethane, trichloroethylene, and dipropylene chloride), a halogenated aromatic hydrocarbon (e.g., ortho-dichlorobenzene), and the like. It is understood that the solvent used in the present invention is not limited to those listed above. Any solvent may advantageously be used in the present invention as long as it can dissolve the polyester composition of the present invention and has a boiling point and a vapor pressure as described above. Applicable solvents other than a halogenated hydrocarbon solvent include, for example, aromatic hydrocarbons (e.g., benzene, toluene, xylene, and trimethylbenzene), phenols (e.g., phenol, and metacresol), alcohols (e.g., benzyl alcohol), nitro hydrocarbons (e.g., a nitrobenzene), nitryl (e.g., acetonitrile), nitride compounds such as amines (e.g., normal butylamine, pyridine, and morpholine), ketones (e.g., acetone, methyl ethyl ketone, methyl isobutyl ketone, and methylcyclohexane), a glycol ether (e. g., dioxane), an ether such as furans (e.g., tetrahydrofuran), an ester (e.g., ethyl acetate, normal butylacetate, andmonoethyl acetate), an organic acid (e.g., a formic acid, an acetic acid, and fluoroacetic acid), an inorganic acid (e.g., a sulfuric acid, and a nitric acid), a sulfur derivative (e.g., carbon disulfide), N,N-dimethylformamide, and the like. Particularly, those with a high volatility are preferred. Among ether solvents, a particularly useful solvent is dioxane.

The solvent or swelling agent preferably has a solubility index in a range of 8.0 to 13.8. However, the solubility index is not limited to this range. From a different point of view, the solvent or swelling agent preferably is such that when the polyester film having a size of 5 cm×1 cm×40 μm is immersed in the solvent or swelling agent at 23° C. for 10 sec, the degree of swelling (as defined below) is 1% or more. However, again, the degree of swelling is not limited to this.

Degree of swelling=((A−B)/B)×100 (%), where

A: the thickness of the film after immersion

B: the thickness of the film before immersion

The above-listed solvents or swellings agent are merely examples, and the present invention is not limited to those shown above. Moreover, the solvents or swelling agents may be used alone or in combination.

Next, a specific example of the method for producing a heat shrinkable polyester film of the present invention will be described, though the present invention is not limited to such a method.

An undrawn film can be obtained by the same method as that described above. The extrusion process may be done with any known method such as a T-die method, or a tubular method.

The obtained undrawn film is then drawn at a temperature equal to or greater than Tg−5° C. and less than Tg+15° C. (where Tg is the glass-transition temperature of the polyester) along the transverse direction (direction perpendicular to the extrusion direction) by a drawing factor of 3.0 or more, and preferably 3.5 or more.

Then, a heat treatment is optionally performed at 70° C. to 100° C. to obtain the heat shrinkable polyester film.

The film may be drawn with a tenter only in the transverse direction, or in two directions, i.e., in the transverse direction and additionally in the longitudinal direction. Such a biaxial drawing may be performed either with a successive biaxial drawing method or a simultaneous biaxial drawing method. After this drawing process, the film may optionally be further drawn in the longitudinal or transverse direction.

In order to achieve the objects of the present invention, it is more practical to have the main shrinkage direction along the transverse direction. Therefore, an exemplary film production method where the main shrinkage direction is along the transverse direction has been described above. However, it is understood that the main shrinkage direction may alternatively be along the longitudinal direction, in which case the above-described method can be used only with the drawn direction being rotated by 90 degrees.

In the present invention, an undrawn film obtained from a polyester is preferably drawn at a temperature of equal to or greater than Tg−5° C. and less than Tg+15° C.

It is not preferable to draw the film at a temperature less than Tg−5° C. In such a case, a sufficient heat shrinkage, a feature of the present invention, may not be obtained, and further the transparency of the obtained film may deteriorate.

It is also not preferable to draw the film at a temperature of Tg+15° C. or more. In such a case, the film may not have a sufficient rigidity in high-speed processes, and further the film may have a substantially increased thickness variation.

The heat shrinkable polyester film of the present invention preferably has a film thickness distribution of 6% or less, and more preferably 5% or less. The film thickness distribution can be calculated based on the following expression: Thickness variation=((maximum thickness−minimum thickness)/average thickness)×100 (%).

A three-color printing test is performed to evaluate the shrunk finish property of the film. With a film having a thickness distribution of 6% or less, it is easy to superimpose the colors on one another. However, with a film having a thickness distribution greater than 6%, the colors may not be desirably superimposed on one another.

In order to reduce the thickness distribution of a heat shrinkable polyester film, it is preferred to heat the film to a predetermined temperature with hot air at a low flow rate such that the heat transfer coefficient is 0.0013 cal/cm²·sec·° C. or less in a pre-heat process, which is performed before the drawing process for drawing the film with a tenter in the transverse direction.

In order to suppress generation of heat inside the film associated with the drawing process and thus to reduce the film temperature non-uniformity in the width direction, the heat transfer coefficient in the drawing process should be 0.0009 cal/cm²·sec·° C. or more, and preferably 0.0011 to 0.0017 cal/cm²·sec·° C.

When the heat transfer coefficient in the pre-heat process exceeds 0.0013 cal/cm²·sec·° C. or when that in the drawing process is 0.0009 cal/cm²·sec·° C. or less, the thickness is likely to be non-uniform. In such a case, when a multi-color printing is performed on the obtained film, the colors of a printed pattern may not be properly superimposed on one another.

### (EXAMPLES)

The present invention will now be described in greater detail by way of examples. However, the present invention is not limited to these examples, but other examples may be possible without departing from the scope of the present invention.

The evaluation methods used in the present invention will now be described with reference to Table 1 and Table 2 below.

(1) Heat Shrinkage

A sheet of film was cut into 10 cm'10 cm pieces, and subjected to a no-load treatment in hot water at a temperature ±0.5° C. of a predetermined temperature so as to heat-shrink the film. Then, the longitudinal and transverse dimensions of the film were measured so as to obtain the heat shrinkage of the film according to the following expression (Expression 1). The direction along which the heat shrinkage was greater was assumed to be the main shrinkage direction of the film.
Heat shrinkage={(length before shrinkage−length after shrinkage)/length before shrinkage)×100 (%) (Expression 1)
(2) Refractive Index

An Abbe refractometer was used to measure the refractive index of the film along the longitudinal, transverse and thickness directions of the film.

In Table 1 below, the refractive index of the film along the longitudinal direction (main shrinkage direction) is denoted by Nx, and the refractive index along the transverse direction (direction perpendicular to the main shrinkage direction) is denoted by Ny.

(3) Solvent Adhesiveness

The film was rolled into a tubular shape with two of its opposite edges bonded together with 1,3-dioxolane. The tubular film was cut into smaller pieces (samples) each having a width of 15 mm in a transverse direction which is perpendicular to the direction along which the film runs through the processing system. The bonded portion was pulled along the transverse direction and peeled apart. In the column “Solvent adhesiveness” in Table 1, “◯” indicates a sample which had a sufficient peel resistance.

(4) Shrunk Finish Property

Each sample was placed around commercially available food container cans (“Friskie” manufactured by Friskie) and passed through Universal Shrinker (Model: K2000) manufactured by Kyowa Denki for a shrinker passage time of 15 sec (zone 1 temperature/zone 2 temperature)=(170° C./170° C.) to shrink the sample onto the cans. The finish property of each shrunk sample was evaluated as follows (10 samples were evaluated). After the evaluation, each sample was marked as follows.

◯: No apparent defect observed

×: Crease or insufficient shrinkage observed

(5) Vibration Test

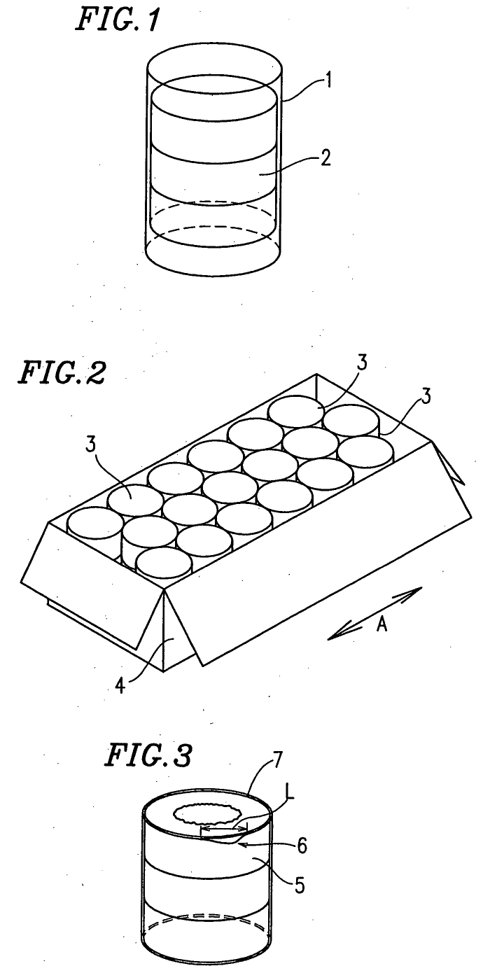

Referring to FIG. 1, each film sample was rolled into a tube 1, with two of its opposite edges being bonded together, and then the tube 1 was placed around a vertical stack 2 (total weight: 660 g) of three food container cans each having a diameter of 72 mm and a height of 55 mm. The can stack 2 with the tube 1 placed therearound was passed through a shrink tunnel to shrink the tube 1 onto the can stack 2. Then, as shown in FIG. 2, a total of 18 packs of such can stacks 3 were placed into a cardboard box 4 having a length of 455 mm, a width of 230 mm and a height of 165 mm (6 packs in the length direction by 3 packs in the width direction), and the cardboard box 4 was sealed.

The cardboard box 4 was vibrated along the longitudinal direction (indicated by arrow A in the figure) for 30 min by a stroke of 50 mm and at a vibration rate of 180 reciprocations/min, after which the transverse tearage of the tube 1 was visually observed.

Referring to FIG. 3, the defect percentage (%) was determined based on the number of defective packs per 18 packs, wherein the defective pack was any pack having a tear flaw 6 whose length (“L” in FIG. 3)is 30 mm or longer in a film 7 along a periphery of the can 5. Then, a sample having a defect percentage of 20% or less was marked “◯”, and a sample having a defect percentage exceeding 20% less was marked “×”.

(6) Actual Shipping Test

Three of such cardboard boxes 4 as described above in the section “Vibration test” were transported by land over a predetermined distance. The defect percentage (%) was determined based on the number of defective packs per 54 packs. Then, a sample having a defect percentage of 20% or less was marked “◯”, and a sample having a defect percentage exceeding 20% less was marked “×”.

(7) Adhesive Retention of Bonded Portion (Backlining Portion)

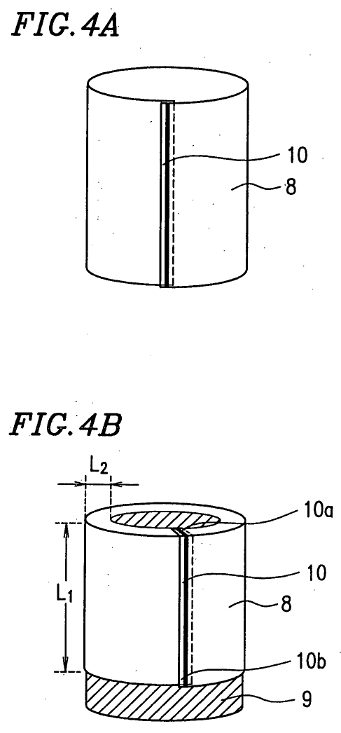

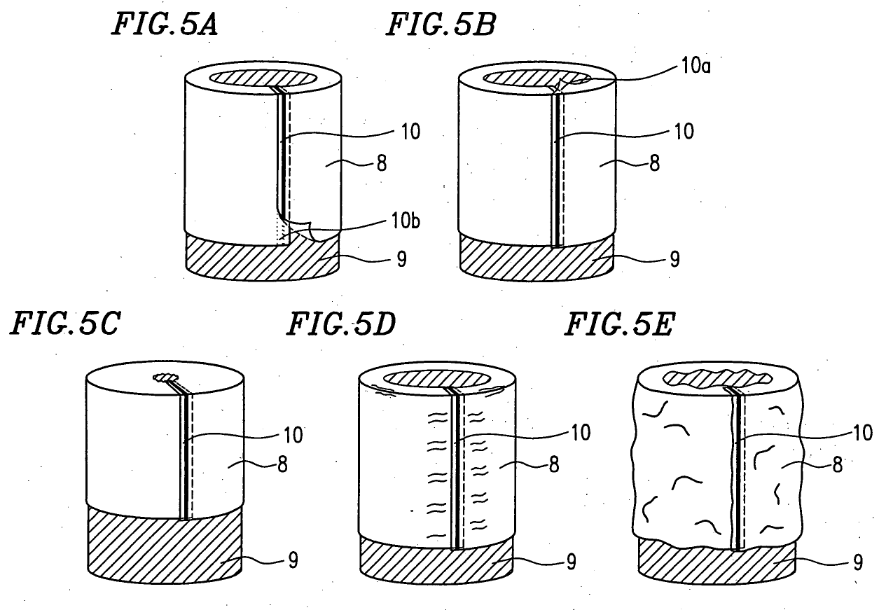

A heat shrinkable polyester film was passed through a tube production apparatus, where 1,3-dioxolane was applied over a width of 2 mm on one side of the film at one edge. Immediately, the film was rolled into a tubular film and the edge was bonded onto the opposite edge. The tubular film was cut into smaller pieces to obtain a label 8 having a diameter of 87 mm and a length of 53 mm as shown in FIG. 4A. As shown in FIG. 4B, the label 8 was placed around a metal cylinder 9 having a diameter of 46 mm, and the label 8 was heat-shrunk onto the metal cylinder 9 through a process at a temperature of 200° C. for 2 sec. Then, the condition and the strength of a bonded portion 10 were evaluated (a total of 200 (1000) samples were evaluated). In FIG. 4B, the length L₁ was 47 mm, the length L₂ was 6 mm, and the width of the bonded portion 3 was 5 mm. The evaluation was done by visual observation with the criteria shown below. The following expression (Expression 2) was used to obtain the adhesive retention of the bonded portion (backlining portion).
Adhesive retention of the bonded portion (backlining portion)=((number of samples evaluated×number of defectives)/number of samples evaluated)×100(%) (Expression 2)
(Criteria)

A sample was considered defective if, after shrinkage, peeling had occurred in an upper portion 10a, in a lower portion 10b, or generally along the entire length of the bonded portion 10. A sample was also considered defective if, after shrinkage, the upper portion 10a and/or the lower portion 10b could be easily peeled by hand. Otherwise, the sample was considered non-defective.

FIG. 5A shows a case where peeling occurred in the lower portion lob of the label 8. FIG. 5B shows a case where peeling occurred in the upper portion 10a of the label 8.

(8) Preform Finish Property and Defect Percentage

For each of the shrunk labels evaluated as described in section (7) above, the shrink property and the finish property of the entire label including the bonded portion were evaluated(a total of 200(1000) samples were evaluated). The evaluation was conducted by visual observation with the criteria shown below. Then, the preform finish defect percentage (total number of samples evaluated=1000) was obtained by the following expression.
Preform finish defect percentage=(number of defectives/number of samples evaluated)×100 (%)

After the evaluation, each sample was marked as follows.

◯: No crease, no jumping, or no insufficient shrinkage observed

×: Crease, jumping, or insufficient shrinkage observed

FIG. 5C shows a case where jumping occurred in the sample. FIG. 5D shows a case where crease occurred in the sample. FIG. 5E shows a case where insufficient shrinkage occurred in the sample.

(9) Shrinkage after Preform Process

For each of the shrunk labels evaluated as described in section (7) above, the bonded portion (backlining portion) 10 was cut off from the label 8, and the remainder was cut into pieces each having a size of 100 mm along the main shrinkage direction by 40 mm along the direction perpendicular to the main shrinkage direction. The label pieces were further heat-shrunk through a no-loadtreatment in hot water at a temperature of 80±0.5° C. for 5 sec. Then, the length of each label piece along the main shrinkage direction and that along the perpendicular direction were measured. The shrinkage after a preform process was obtained by the following expression (Expression 3).
Shrinkage after preform=((length before shrinkage×length after shrinkage)/length before shrinkage)×100(%) (Expression 3)
(10) Tg (Glass-Transition Temperature)

DSC (model: DSC220) manufactured by Seiko Instruments & Electronics Ltd was used to raise the temperature of an undrawn film (10 mg) from −40° C. to 120° C. at a temperature rising rate of 20° C./min to obtain an endothermic curve. The glass-transition temperature of the film was obtained based on the obtained endothermic curve. A tangential line was drawn immediately before and after an inflection point along the endothermic curve to obtain Tg (glass-transition temperature) at the intersection between the tangential lines.

(11) Film Haze

“1001DP” manufactured by Nihon Denshoku Kogyo was used to measure the haze of each film sample in compliance with JIS (Japanese Industrial Standards) K 7105.

The following polyesters (Polyesters A-E) were used in the examples and comparative examples to be described below.

Polyester A: polyethylene terephthalate (intrin-sic viscosity (IV): 0.75 dl/g)

Polyester B: a polyester comprising 100 mol % of terephthalic acid, 70 mol % of ethylene glycol, and 30 mol % of neopentyl glycol (IV: 0.72 dl/g)

Polyester C: polybutylene terephthalate (IV: 1.20 dl/g)

Polyester D: a polyester comprising 100 mol % of terephthalic acid, 85 mol % of butanediol, and 15 mol % of polytetramethylene glycol (molecular weight: 1000) (IV: 1.50 dl/g)

Polyester E: a polyester elastomer comprising a copolymer polyester of 70 wt % of Polyester C and 30 wt % of ε-caprolactone (reduced viscosity (η^{sp/c}): 1.30 dl/g)

### (Example 1)

A polyester obtained by mixing together 37 wt % of Polyester A, 53 wt % of Polyester Band 10 wt % of Polyester C, as shown in Table 1, was melted and extruded through a T die at a temperature of 280° C., and rapidly cooled down by using a chill roll to obtain an undrawn film. The undrawn film was drawn in the longitudinal direction by a drawing factor of 1.1 by using a multi-stage roll type vertical drawer (roll temperature: 80° C.), and then drawn with a tenter in the transverse direction at the film temperature of 73° C. by a drawing factor of 3.9. The film was then subjected to a heat treatment at 82° C. for 10 sec to obtain a heat shrinkable polyester film having a thickness of 45 μm.

### (Examples 2-4 and Comparative Examples 1-4)

A heat shrinkable polyester film having a thickness of 45 μm was obtained in a manner similar to that of Example 1 except that different polyester ratio and drawing conditions were used as shown in Table 1.

The evaluation results for the respective films of Examples 1-4 and Comparative Examples 1-4 are shown together in Table 1.

TABLE 1

| | | | | Film production condition | | | | | |
|---|---|---|---|---|---|---|---|---|---|
| | | | | Longitudinal | | Transverse | | | |
| | Material | | | drawing | | drawing | | Hot water shrinkage | |
| | Polyester | Polyester | Polyester | Drawing | Drawing | Drawing | Drawing | 95° C. · 10 sec (%) | |
| | A | B | C | temperature | factor | temperature | factor | Longitudinal | Transverse |
| Example 1 | 37 | 53 | 10 | 80 | 1.1 | 73 | 3.9 | 14.0 | 62.0 |
| Example 2 | 37 | 53 | 10 | 80 | 1.3 | 77 | 3.9 | 21.0 | 64.0 |
| Example 3 | 30 | 60 | 10 | 80 | 1.2 | 77 | 3.9 | 18.0 | 65.0 |
| Example 4 | 26 | 50 | 24 | 80 | 1.3 | 77 | 3.9 | 19.0 | 70.0 |
| Comparative | 37 | 53 | 10 | — | (1.0) | 73 | 3.9 | 7.0 | 60.0 |
| example 1 | | | | | | | | | |
| Comparative | 26 | 50 | 24 | 80 | 1.1 | 77 | 3.9 | 13.0 | 70.0 |
| example 2 | | | | | | | | | |
| Comparative | 10 | 66 | 24 | 80 | 1.2 | 78 | 3.9 | 15.0 | 68.0 |
| example 3 | | | | | | | | | |
| Comparative | 15 | 75 | 10 | 80 | 1.2 | 76 | 3.9 | 16.0 | 74.0 |
| example 4 | | | | | | | | | |

| | | | | | Shock | Shock |
|---|---|---|---|---|---|---|
| | | | | | resistance | resistance |
| | Refractive | | | Shrunk | in | in |
| | index | | Solvent | finish | vibration | actual |
| | Nx | Ny-Nx | adhesiveness | property | test | shipping |
| Example 1 | 1.562 | 0.061 | ◯ | ◯ | 11◯ | ◯ |
| Example 2 | 1.563 | 0.050 | ◯ | ◯ | 11◯ | ◯ |
| Example 3 | 1.562 | 0.055 | ◯ | ◯ | 17◯ | ◯ |
| Example 4 | 1.563 | 0.060 | ◯ | ◯ | 17◯ | ◯ |
| Comparative | 1.560 | 0.072 | ◯ | ◯ | 56X | X |
| example 1 | | | | | | |
| Comparative | 1.560 | 0.068 | ◯ | ◯ | 56X | X |
| example 2 | | | | | | |
| Comparative | 1.561 | 0.044 | ◯ | ◯ | 44X | X |
| example 3 | | | | | | |
| Comparative | 1.558 | 0.059 | ◯ | ◯ | 50X | X |
| example 4 | | | | | | |

### (Example 5)

A polyester composition obtained by mixing together 36 wt % of Polyester A, 49 wt % of Polyester B and 15 wt % of Polyester E, as shown in Table 2, was melted and extruded through a T die at a temperature of 280° C., and rapidly cooled down by using a chill roll to obtain an undrawn film.

The undrawn film was pre-heated until the film temperature reached 80° C., after which the film was drawn with a tenter at a temperature of 65° C. in the transverse direction by a drawing factor of 4.0 to obtain a heat shrinkable polyester film having a thickness of 50 μm.

### (Example 6)

A polyester composition obtained by mixing together 36 wt % of Polyester A, 49 wt % of Polyester B and 15 wt % of Polyester E, as shown in Table 2, was melted and extruded through a T die at a temperature of 280° C., and rapidly cooled down by using a chill roll to obtain an undrawn film.

The undrawn film was pre-heated until the film temperature reached 80° C., after which the film was drawn with a tenter at a temperature of 70° C. in the transverse direction by a drawing factor of 4.0 to obtain a heat shrinkable polyester film having a thickness of 50 μm.

### (Example 7)

A polyester composition obtained by mixing together 26 wt % of Polyester A, 54 wt % of Polyester B and 20 wt % of Polyester E, as shown in Table 2, was melted and extruded through a T die at a temperature of 280° C., and rapidly cooled down by using a chill roll to obtain an undrawn film.

The undrawn film was pre-heated until the film temperature reached 80° C., after which the film was drawn with a tenter at a temperature of 65° C. in the transverse direction by a drawing factor of 4.0 to obtain a heat shrinkable polyester film having a thickness of 50 μm.

### (Example 8)

A polyester composition obtained by mixing together 26 wt % of Polyester A, 54 wt % of Polyester B and 20 wt % of Polyester E, as shown in Table 2, was melted and extruded through a T die at a temperature of 280° C., and rapidly cooled down by using a chill roll to obtain an undrawn film.

The undrawn film was pre-heated until the film temperature reached 80° C., after which the film was drawn with a tenter at a temperature of 70° C. in the transverse direction by a drawing factor of 4.0 to obtain a heat shrinkable polyester film having a thickness of 50 μm.

### (Comparative Example 5)

A polyester composition obtained by mixing together 26 wt % of Polyester A, 45 wt % of Polyester B, 24 wt % of Polyester C, and 5 wt % of Polyester D, as shown in Table 2, was melted and extruded through a T die at a temperature of 280° C., and rapidly cooled down by using a chill roll to obtain an undrawn film.

The undrawn film was pre-heated until the film temperature reached 80° C., after which the film was drawn with a tenter at a temperature of 68° C. in the transverse direction by a drawing factor of 4.0 to obtain a heat shrinkable polyester film having a thickness of 50 μm.

### (Comparative Example 6)

A polyester composition obtained by mixing together 26 wt % of Polyester A, 50 wt % of Polyester B and 24 wt % of Polyester C, as shown in Table 2, was melted and extruded through a T die at a temperature of 280° C., and rapidly cooled down by using a chill roll to obtain an undrawn film.

The undrawn film was pre-heated until the film temperature reached 80° C., after which the film was drawn with a tenter at a temperature of 65° C. in the transverse direction by a drawing factor of 4.0 to obtain a heat shrinkable polyester film having a thickness of 50 μm.

### (Comparative Example 7)

A polyester composition obtained by mixing together 7 wt % of Polyester A, 68 wt % of Polyester B and 25 wt % of Polyester C, as shown in Table 2, was melted and extruded through a T die at a temperature of 280° C., and rapidly cooled down by using a chill roll to obtain an undrawn film.

The undrawn film was pre-heated until the film temperature reached 80° C. after which the film was drawn with a tenter at a temperature of 75° C. in the transverse direction by a drawing factor of 4.0 to obtain a heat shrinkable polyester film having a thickness of 50 μm.

The evaluation results for the respective films of Examples 5-8 and Comparative Examples 5-7 are shown together in Table 2.

TABLE 2

| | | | | | | | | | | Adhesive | | Preform | | |
|---|---|---|---|---|---|---|---|---|---|---|---|---|---|---|
| | Material | | | | | Film production | | | | retention | | finish | Shrinkage | |
| | Poly- | Poly- | Poly- | Poly- | Poly- | condition | | Shrinkage | | (%) of | Preform | defective | after | Film |
| | ester | ester | ester | ester | ester | Drawing | Drawing | (5 sec) | | backlining | finish | percentage | preform | haze |
| | A | B | C | D | E | temperature | factor | 70° C. | 95° C. | portion | property | (%) | (%) | (%) |
| Example 5 | 36 | 49 | 0 | 0 | 15 | 65 | 4.0 | 30.0 | 68.0 | 95.0 | ◯ | 0.5 | 20.0 | 8 |
| Example 6 | 36 | 49 | 0 | 0 | 15 | 70 | 4.0 | 23.0 | 63.0 | 97.0 | ◯ | 1.0 | 16.0 | 7 |
| Example 7 | 26 | 54 | 0 | 0 | 20 | 65 | 4.0 | 35.0 | 67.0 | 99.0 | ◯ | 0.5 | 22.0 | 5 |
| Example 8 | 26 | 54 | 0 | 0 | 20 | 70 | 4.0 | 27.0 | 61.0 | 99.5 | ◯ | 1.0 | 18.0 | 4 |
| Comparative | 26 | 45 | 24 | 5 | 0 | 68 | 4.0 | 30.0 | 65.0 | 90.0 | ◯ | — | 20.0 | 13 |
| example 5 | | | | | | | | | | | | | | |
| Comparative | 26 | 50 | 24 | 0 | 0 | 65 | 4.0 | 35.0 | 74.0 | 95.0 | X | 2.0 | 31.0 | 7 |
| example 6 | | | | | | | | | | | | | | |
| Comparative | 7 | 68 | 25 | 0 | 0 | 75 | 4.0 | 21.0 | 68.0 | 99.0 | X | 5.0 | 33.0 | 5 |
| example 7 | | | | | | | | | | | | | | |

As is apparent from Table 1, each of the heat shrinkable polyester films obtained in Examples 1-4 exhibits a good shrunk finish property (no defects such as insufficient shrinkage, crease, distortion are observed), a good solvent adhesiveness, a good shock resistance in the vibration test and a good shock resistance in the actual shipping test.

Thus, the heat shrinkable polyester film of the present invention is a film having a high quality and a high practicability which is suitable as a multi-packaging label for cans and can be used under low temperatures.

On the contrary, the heat shrinkable polyester films obtained in Comparative Examples 1-4 exhibited a poor shock resistance. Thus, each of the heat shrinkable polyester films of the comparative examples exhibited a poor quality and a poor practicability.

As is apparent from Table 2, for each of the films obtained in Examples 5-8, the bonded portion (backlining portion) of the label produced from the film exhibited a high adhesive retention. Each of the films also exhibited a good shrunk finish property. The films obtained in Examples 5-8 exhibited a low film haze and a good transparency. Moreover, the films obtained in Examples 5-8 exhibited a hot water shrinkage after a preform process of 15% to 30% along the main shrinkage direction for a hot water process at 80° C. for 5 sec. The labels of Examples 5-8 also exhibited a good shrunk finish property.

The heat shrinkable polyester film of the present invention has a high quality and a high practicability, and is particularly suitable as a cap sealing label.

On the contrary, for each of the heat shrinkable films obtained in Comparative Examples 5-7, the bonded portion (backlining portion) of the label produced from the film exhibited a poor adhesive retention. Moreover, the film obtained in Comparative Example 5 exhibited a high film haze and thus a poor transparency. Moreover, each of the films obtained in Comparative Examples 6 and 7 exhibited a high hot water shrinkage after a preform process, and a poor shrunk finish property. Thus, each of the heat shrinkable polyester films obtained in Comparative Examples 5-7 had a poor quality and a low practicability.

Thus, the heat shrinkable polyester film of the present invention has a good shock resistance during shipping especially under low temperatures, with a good finish after shrinkage and a sufficient solvent adhesiveness.

Therefore, the heat shrinkable polyester film of the present invention is suitable for use in a multi-packaging label for packaging, inter alia, a stack of cans.

The present invention also provides a heat shrinkable polyester film suitable for use in a label, especially, a cap sealing label for a bottle container, or the like.

When the heat shrinkable polyester film of the present invention is used as a cap sealing label, the bonded portion (backlining portion) of the label has a high adhesive retention after shrinkage and has very little crease, shrinkage non-uniformity, distortion, or jumping occurring from a shrinkage process. Thus, the heat shrinkable polyester film of the present invention is very useful as a cap sealing label.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A heat shrinkable polyester film having a transverse tear defect percentage of about 20% or less as determined in the following vibration test:
the film is rolled into a tubular shape, two of its opposite edges bonded together, and then the tubular film is placed around a vertical stack (total weight: 660 g) of three food container cans each having a diameter of 72 mm and a height of 55 mm; the can stack with the tubular film placed therearound is passed through a shrink tunnel to shrink the tubular film onto the can stack; a total of 18 packs of such can stacks are placed into a cardboard box having a length of 455 mm, a width of 230 mm and a height of 165 mm (6 packs in the length direction by 3 packs in the width direction), and the cardboard box is sealed; the cardboard box is vibrated along the width direction for 30 min by a stroke of 50 mm and at a vibration rate of 180 reciprocations/min, after which the transverse tearage of the tubular film is visually observed; and the transverse tear defect percentage (%) is determined based on the number of defective packs per 18 packs, wherein the defective pack is any pack having a tear flaw of 30 mm or longer along a can periphery.

2. A heat shrinkable polyester film according to claim 1, wherein the film has a longitudinal refractive index Nx and a transverse refractive index Ny which satisfy the following expressions (1) and (2):
1.561<Nx<1.566 (1); and
0.040<Ny−Nx<0.070 (2).

3. A heat shrinkable polyester film according to claim 1, wherein the film has a shrinkage of about 50% or more along its main shrinkage direction when the film is put in hot water of 95° C. for 10 sec.

4. A heat shrinkable polyester film according to claim 1, wherein the film has a shrinkage of about 10% to about 25% along a direction perpendicular to its main shrinkage direction when the film is put in hot water of 95° C. for 10 sec.

5. A heat shrinkable polyester film according to claim 1, wherein the film has a solvent adhesiveness with 1,3-dioxolane.

6. A heat shrinkable polyester film according to claim 1, wherein the film can be used as a multi-packaging film.
